(19) United States
(12) Patent Application Publication
(10) Pub. No.: US 2007/0206140 A1
(43) Pub. Date: Sep. 6, 2007

(54) Wide viewing angle liquid crystal display

(75) Inventors: Dai-Liang Ting, Hsinchu City (TW); Li-Sen Chuang, Husi Township (TW)

Correspondence Address: LIU & LIU, 444 S. FLOWER STREET, SUITE 1750, LOS ANGELES, CA, 90071, US

(73) Assignee: Toppoly Optoelectronics Corp.

(21) Appl. No.: 11/367,078

(22) Filed: Mar. 3, 2006

(51) Int. Cl. G02F 1/1337

(52) U.S. Cl. 349/123

(57) ABSTRACT

An LCD panel having a novel substrate structure, which has optical characteristics that extend the range of horizontal viewing angles with improved contrast ratio, and that extend range of vertical viewing angles with reduced grayscale inversion effect. In one aspect, the substrate structure includes an alignment layer provided with a plurality of first alignment grooves that are aligned at an angle close to an axis parallel to one edge of the display area. The angle may be 0° or ranges from +20° to −20° relative to the edge of the display area. The LCD panel comprises two opposing substrate structures, with the alignment grooves orthogonal to each other.

### BACKGROUND OF THE INVENTION

1. Field of the Invention

The present invention relates to a liquid crystal display, and more particularly to a liquid crystal display that employs a novel arrangement of its optical axes to provide a wide range of viewing angles.

2. Description of Related Art

Liquid crystal display (LCD) panel is a thin display technology that is commonly used in television displays, computer displays, and handheld electronics (e.g., cellular phones, personal digital assistants (PDAs), etc.). A typical LCD panel consists of a light-polarizing liquid crystal layer that is contained between two thin transparent alignment layers that are supported by two glass plates to create a liquid crystal cell. During manufacturing of the LCD panel, and in particular twisted-nematic LCD panel, the inside surfaces of the alignment layers are rubbed by a roller covered with a velvet cloth to create microscopic parallel grooves. These microscopic grooves help align the long axes of the liquid crystal molecules to be in the same direction as the grooves. The two alignment layers are subsequently arranged so that their groove directions are perpendicular to each other, causing the orientations of the liquid crystal molecules to gradually “twist” into an overall helix. When the liquid crystal molecules are in this 90° twisted-nematic state, any polarized light passing through the liquid crystal layer will also has its polarization rotated by about 90°. Therefore, when two polarizers are placed outside the glass plates with their polarizing axes oriented perpendicular to each other, and each parallel to the rubbing direction of its adjacent alignment layer, any light passing through one polarizer is redirected 90° along the helix arrangement of the liquid crystal molecules so that the light can pass through the second polarizer. When an electrical field is applied to the liquid crystal molecules, the molecules rearrange themselves so that they can no longer rotate the phase angle of the light, causing any light entering through one polarizer to be blocked by the second polarizer.

Heretofore, the images displayed by prior art LCD panels appear to have different image qualities (e.g., contrast ratio) to observers at different viewing angles with respect to the panel. Efforts have been made to design LCD displays to accommodate observers viewing the displayed image not only from viewing locations directly in front of the display, but also from viewing locations at angles oblique to the display, such as along the horizontal plane when the observers are in a sitting position in the case of a television display, for example. For some applications such as computer displays, it would be desirable to accommodate observers at various viewing angles, both in the horizontal and vertical planes, to view the image that is on display. Therefore, a larger range of viewing angles would be desirable. Further, for applications where the observers' coverage of the entire area of the display from a single viewing location creates appreciable different viewing angles with respect to the display, for example when an observer sits close to the display and/or the display is relatively large, the displays should provide a greater range of viewing angles to a single viewing location, so to avoid variation in the perceived image quality at various locations across the display (e.g., left, right and center of the display). For handheld displays, they are usually smaller, but positioned in front of the observer sometimes at extreme angles in planes other than the horizontal plane (e.g., in the vertical plane). Therefore, a handheld device that employs an LCD panel should have good display characteristics over a wide range of vertical viewing angles as well.

One problem with twisted-nematic LCD is that the liquid crystal cell can cause a birefringence effect on the passing light, changing the color of the passing light and posing a problem for black and white display characteristics. Another problem with twisted-nematic LCD is that the liquid crystal molecule 100 does not lie flat relative to the alignment layer 228. Instead, the molecule 100 points slightly up at a pretilt angle (φ) of between 2° to 6° from the horizontal orientation A as seen in FIG. 1. This pretilt angle is important for the proper function of the display but also causes the contrast of the displayed images to vary greatly depending on the viewing angle of the observer. As a result, various types of optical compensation films have been proposed that are placed between the polarizer and the glass plate to improve the black and white color characteristics and to decrease the viewing angle dependency problem.

In a prior art twisted-nematic LCD cell 200 schematically represented in FIG. 2 and FIG. 3, the microscopic grooves 210 and 212 on the front and rear alignment layers 220 and 230 are created in such a way that the front layer 220 (facing towards the viewer) has its grooves 210 oriented at approximately 45° while the rear layer 230 has its grooves 212 oriented at approximately −45° to the X-axis of the screen. These diagonal groove directions 214 force the horizontal direction A (with respect to the X-axis) of the liquid crystal molecules 100 to change from 45° to −45° as shown in FIG. 3. This diagonal orientation 214 allows the displayed images to have a balanced brightness level between the left and right side of the screen during normal operation. However, this diagonal orientation 214 also results in a poor image contrast ratio especially when the displayed image is viewed at viewing angles from the left, right, top or bottom sides of the display. As the viewing angle increases beyond a certain angle in the vertical plane, a grayscale inversion phenomenon may appear where bright pixels appear dark and dark pixels appear bright that can render the displayed image unintelligible.

To facilitate explanation of the viewing angles and related image characteristics, the coordinates convention shown in FIG. 4 is adopted in relation to an LCD panel defining a rectangular display area, where the X-axis and the “bottom” edge of the display area are parallel to the horizon of the observer. The Z-axis is the surface normal and a displayed image on the LCD panel will have its “up” direction (Y-axis) at θ=90°. The plane that is formed by the “up” direction and the Z-axis is the vertical plane 300. The side where light is emitted from the panel is considered the “front” side and the side where light enters the panel is considered its “rear” side (not shown).

FIG. 11a is a plot of the contrast ratio versus viewing angles about a spot at the middle layer (i.e., the center of the thickness of the LC layer) of a prior art LCD panel, essentially representing the contrast ratio of the views from all locations in a hemispherical domain that is centered about the spot. The circles 500 represent the coordinates of viewing angles, increasing from the center of the circles outwards. The shaded areas represent the contrast ratio values. In the particular example shown in FIG. 11a, the solid dark areas 502 represent contrast ratio values of greater than 50 at the corresponding viewing angles and viewing locations. The gray shaded areas 504 represent contrast ratio values of less than 50 at the corresponding viewing angles and viewing locations. The hatched shaded areas 506 represent gray scale inversion at the corresponding viewing angles and viewing locations. The direction of the liquid crystal 508 at the mid section in the liquid crystal layer is schematically represented in FIG. 11a.

For the prior art LCD panel represented by the plot in FIG. 11a, it has been found that the contrast ratio of the display could decrease significantly at viewing angles beyond about 40 degrees from the normal to the display (i.e., Z direction), for viewing positions on the left, right and top sides of the panel. In addition, the gray scale inversion is present at viewing angles beyond about 40 degrees from the normal, for viewing positions on the bottom of the panel. However, heretofore, despite the problems noted above, because of the desire to balance left and right symmetry in contrast ratio characteristics (i.e., for viewing angles in the horizontal plane, about the vertical axis), prior art LCD panels continue to configure the alignment layers with diagonally aligned grooves.

As LCD panels become larger in display size, as well as making their way into more electronic and handheld devices that are operated with the displays viewed at large viewing angles, the contrast ratio and grayscale inversion problems become more noticeable. Therefore, what is needed is a LCD panel that provides a high contrast ratio over a wide range of vertical viewing angles.

### SUMMARY OF THE INVENTION

The present invention is directed to an LCD panel having a novel substrate structure, which has optical characteristics that extend the range of horizontal viewing angles with improved contrast ratio, and that extend range of vertical viewing angles with reduced grayscale inversion effect. In one aspect of the present invention, the substrate structure includes an alignment layer provided with a plurality of first alignment grooves that are aligned at an angle close to an axis parallel to one edge of the display area. In one embodiment, the angle ranges from +20° to −20° relative to the edge of the display area. In another embodiment, the angle is substantially 0° relative to the edge of the display panel. The LCD panel comprises a first and second substrate structures opposing each other, each having the novel alignment layer with alignment grooves aligned at an angle close to an axis parallel to one edge of the display area. The alignment grooves of the two substrate structures are orthogonal to each other.

### BRIEF DESCRIPTION OF THE DRAWINGS

For a fuller understanding of the nature and advantages of the invention, as well as the preferred mode of use, reference should be made to the following detailed description read in conjunction with the accompanying drawings. In the following drawings, like reference numerals designate like or similar parts throughout the drawings.

FIG. 1 is a perspective view showing the pretilt angle (φ) of the liquid crystal molecule relative to the surface of an alignment layer.

FIG. 2 is a perspective view depicting the rubbing and microscopic groove directions of the alignment layers with respect to a horizontal axis in a prior art LCD panel.

FIG. 3 is a perspective view showing the position of the liquid crystal molecules in a twisted-nematic state with respect to a horizontal axis in a prior art LCD panel.

FIG. 4 is a perspective view defining the vertical plane and the nomenclature convention used in the description of the present invention.

FIG. 5 is a sectional view of a liquid crystal display panel according to an embodiment of the present invention.

FIG. 6 is a schematic view depicting the alignment layers, compensation layers and optical polarizer films making up the two optical axes according to one embodiment of the present invention. The glass substrates and components not related to the optical axes are omitted to maintain clarity.

FIG. 7 is a perspective view showing the novel arrangement of the liquid crystal molecules in their twisted-nematic state with respect to a horizontal axis on the alignment layers according to an embodiment of the present invention.

FIG. 8a is a top view of the substrate showing the prior art in which the microscopic grooves are being formed on the alignment layer by a roller with a rubbing direction of 45° relative to the raised structures on the substrate.

FIG. 8b is a side view of the substrate of FIG. 8a, showing the substrate surfaces that are being sheltered from the roller by the raised structures when the buffing direction is at 45° relative to the raised structures.

FIG. 9a is a top view of the substrate showing the microscopic grooves being formed on the alignment layer by a roller with a rubbing direction of 0° relative to the raised structures on the substrate, in accordance with one embodiment of the present invention.

FIG. 9b is a side view of the substrate in FIG. 9a, showing the microscopic grooves being created by a roller at substrate surfaces that were previously sheltered by the raised structures.

FIG. 10 is a schematic view of an electronic device comprising a novel LCD panel of the present invention, in accordance with one embodiment of the present invention.

FIG. 11a is a schematic representation of the plot of contrast ratio values versus viewing angles at viewing locations about a spot in the middle layer of a prior art LCD panel.

FIG. 11b is a schematic representation of the plot of contrast ratio values versus viewing angles at viewing locations about a spot in the middle layer of an LCD panel in accordance with one embodiment of the present invention.

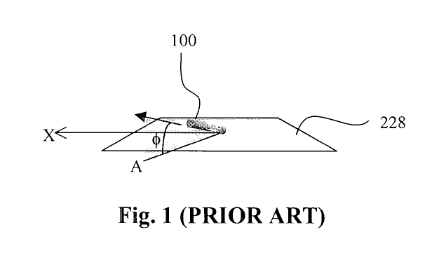

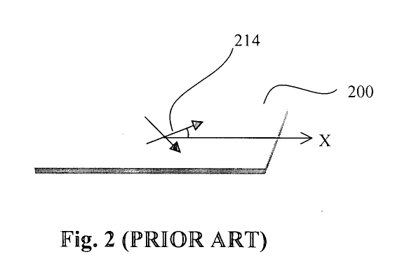

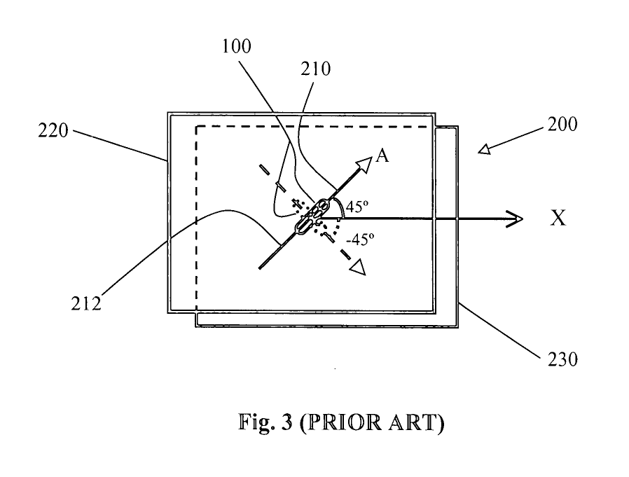

### DETAILED DESCRIPTION OF THE ILLUSTRATED EMBODIMENTS

The present description is of the best presently contemplated mode of carrying out the invention. This description is made for the purpose of illustrating the general principles of the invention and should not be taken in a limiting sense. The scope of the invention is best determined by reference to the appended claims. This invention has been described herein in reference to various embodiments and drawings. It will be appreciated by those skilled in the art that variations and improvements may be accomplished in view of these teachings without deviating from the scope and spirit of the invention.

By way of illustration and not limitation, the present invention will be described in connection with a flat panel display having an LCD panel defining a generally rectangular display area in which an image may be rendered (i.e., an area within which liquid crystals may be aligned and controlled to render an image in accordance with an input image data), and further the LCD panel having a generally rectangular planar structure. As will be evident from the disclosure below, the actual shape of the planar area of the LCD panel may not be as important as compared to the actual display area. For example, the planar area may be oval shaped, but the displayable area can be rectangular shaped. Further, the actual viewable area of the display area may be different, depending on the housing, frame, bracket, or other structures that may block part of the display area from view to an observer. For example, a rectangular display area may have a frame that covers part of its periphery, reducing the viewable area to an oval area. Note that although the LCD panel is described as being constructed and used in landscape mode, the same results can also be obtained when the device is constructed and used in portrait mode where the horizontal edges are shorter than the vertical edges.

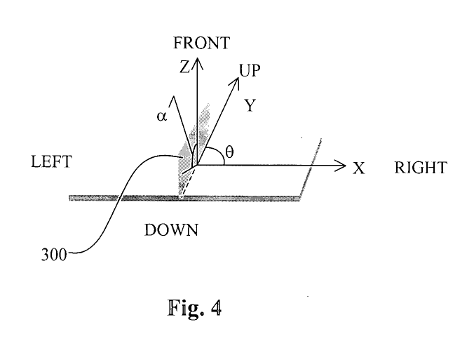

The structure and arrangement of the alignment provide a wider range of viewing angles at least in a horizontal plane, and/or reduces the effect of gray scale inversion along a vertical plane. Throughout the present disclosure, the coordinates convention shown in FIG. 4 is used in relation to a rectangular display where the X-axis and the “bottom” edge of the display area are parallel to the horizon of the observer. The Z-axis is the surface normal and a displayed image on the LCD panel will have its “up” direction (Y-axis) at θ=90°. The plane that is formed by the “up” direction and the Z-axis is the vertical plane 300. The side where light is emitted from the panel is considered the “front” side and the side where light enters the panel (in the case of a transmissive LCD panel) is considered its “rear” side (not shown). In accordance with the present invention, the novel LCD panel uses a pair of alignment layers such that the microscopic grooves on one layer are at an angle close to the X-axis, and the grooves on the second layer is at an angle close to the vertical Y-axis.

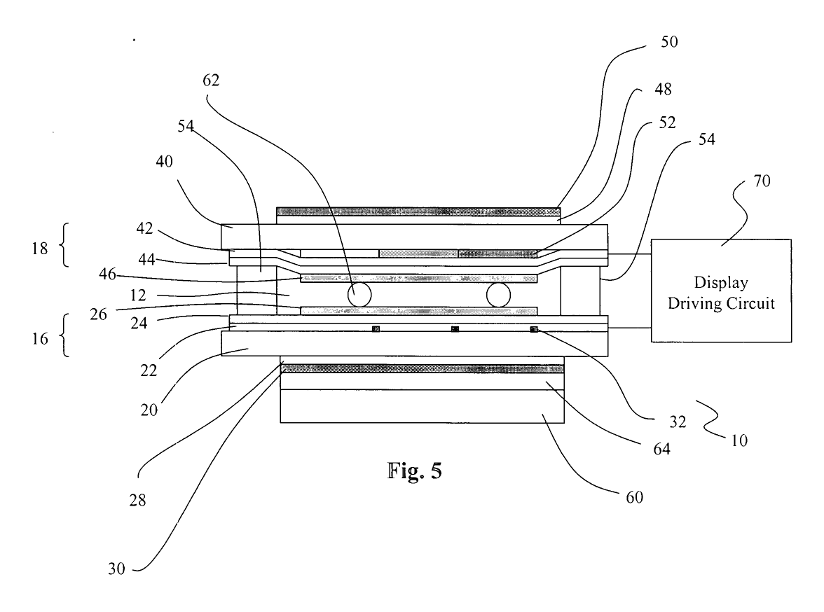

In one embodiment of the present invention that is depicted in FIG. 5, the flat panel 10 comprises a liquid crystal layer 12 that is sandwiched by “front” and “rear” transparent substrate structures 16 and 18. The “rear” transparent substrate structure 16 may be manufactured by first depositing a transparent conductive material 22 such as indium tin oxide (ITO) onto the surface of the “rear” glass substrate 20. The ITO 22 is cleaned and etched using known processes to form an array of rear electrodes to provide electrical connections from the display driving circuit (not shown in FIG. 5) and to define each pixel of the panel 10. For active matrix LCD displays, pixel switching elements such as thin-film transistors 32 based on either amorphous or polycrystalline silicon are formed on the substrate, at each pixel location. A passivation layer 24 may be deposited to protect the circuitry. A thin alignment layer 26, usually made up of a polymer such as polyimide, is then transferred and cured on the “rear” substrate structure 16. Alignment grooves are formed on the alignment layer 26 in accordance with the present invention, as further discussion below.

As shown in FIG. 5, the “front” transparent substrate structure 18 consists of a color filter 52 that is applied to the “front” glass substrate 40 using various known printing techniques. A layer of ITO 42 is then deposited on the color filter and etched to form the “front” electrodes. A passivation layer 44 may be deposited on the ITO to protect the “front” electrodes. An alignment layer 46 is formed on this optional passivation layer 44 and microscopic grooves (not shown) are formed in a direction that is perpendicular to the direction of the microscopic grooves formed on the “rear” substrate structure, in accordance with the present invention, as further discussed below.

A sealant 54 is applied along the perimeter of one of the substrate structures, leaving a small opening, and is pre-baked to stabilize the sealant. Tiny glass or plastic beads 62 are sprayed onto one of the substrate structures to act as spacers. The two substrate structures 16 and 18 are positioned and clamped together so that the microscopic grooves (not shown) on the alignment layer of each substrate remain orthogonal to each other. The sealant 54 is cured and the liquid crystal material 12 is injected by backfill pressure between the substrates through the small opening, which is subsequently sealed to contain the liquid crystal material 12.

A “rear” and “front” optical compensation films 28 and 48 are used to cancel out the bifringent properties of the liquid crystal materials 12. The compensation films 28 and 48 are made up of an organic film that is stretched along two axes to produce a negative birefringent film and are matched to the orientation of the nearest alignment layer so that its negative birefringence properties may cancel out the positive birefringence properties of the twisted-nematic liquid crystal cell. Using known lamination processes, the “front” compensation film 48 is applied such that the refractive index ellipsoid direction can be in the same direction as the microscopic groove direction on the “front” alignment layer 46. The “rear” compensation film 28 is also applied so that its refractive index ellipsoid direction can be in the same direction as the microscopic groove direction of the “rear” alignment layer 26.

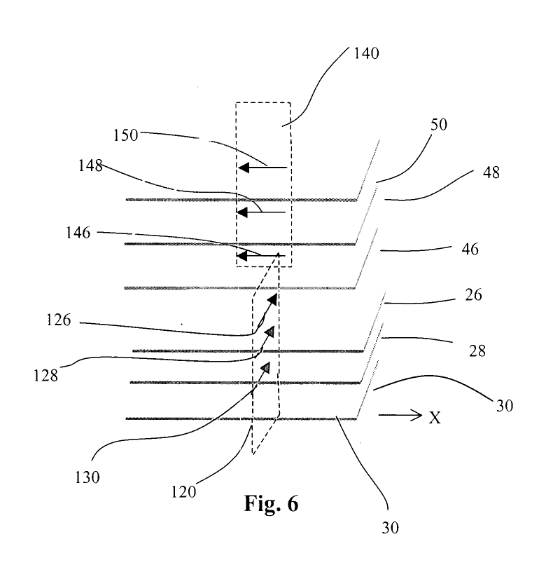

The polarizers 30 and 50 are applied to the front and back of the glass substrates 20 and 40 using known lamination processes. The polarizers 30 and 50 consist of a dye- or iodine-impregnated polymer film that is stretched in one axis, orienting both the film and the optical dopants in the same direction to pass only light that is polarized in a certain direction. As shown in FIG. 6, the “rear” polarizer 30 has its polarization axis 130 in the same direction as the microscopic grooves direction 126 on the “rear” alignment layer 26, which is at 90° relative to the X-axis. The “front” polarizer 50, on the other hand, has its polarization axis 150 at 180° relative to the X-axis to match the microscopic groove direction 146 on the “front” alignment layer 46. The polarization axes 130 and 150 of the polarizers 30 and 50, the refractive index ellipsoid directions 128 and 148 of the compensation layers 28 and 48, and the microscopic groove directions 126 and 146 on the alignment layers 26 and 46 are positioned to form two optical axes 120 and 140. The orthogonal arrangement of the two optical axes 120 and 140 allows polarized light passing through the liquid crystal layer to also pass through the “front” polarizer 50 when the liquid crystal molecules are in their twisted-nematic state. When a voltage is applied from the display driving circuit 70 to the liquid crystal layer 12, the liquid crystal molecules straighten out of their helixical pattern and since they cannot rotate the phase angle of the light passing through them, the polarized light maintains the same polarization state and is subsequently blocked by the “front” polarizer 50.

As shown in FIG. 5, a light source, such as a backlight 60 consisting of miniature cold-cathode fluorescent tubes, an array of light-emitting diodes, or other plasma-based or non-plasma-based lighting source, is used to deliver light through the rear of the LCD panel (in the case of a transmissive LCD panel). A light guide plate 64 is used to uniformly deliver the light from the fluorescent tube 60 to the rear of the LCD. Alternately, the light source may be placed at the edge of the light guide plate, as in the case of an edge-lit LCD panel.

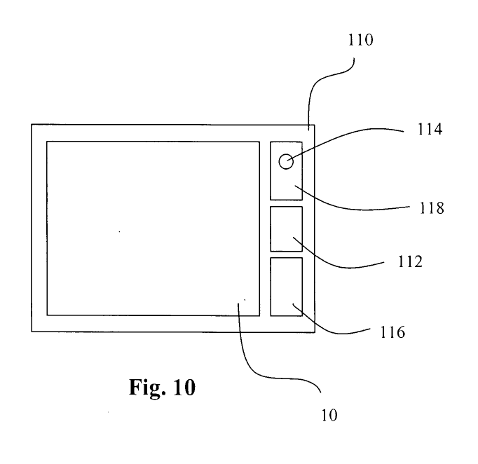

Although FIG. 5 depicted a construction corresponding to one pixel to maintain clarity, it can be appreciated by one skilled in the art that the construction can be scaled to form an array of many pixels that covers the surface of an LCD panel. As seen in FIG. 10, an electronic 110 (which may be one of a PDA, mobile phone, television, display monitor, portable computer, refrigerator, etc.) comprises a novel inventive LCD panel 10 in accordance with one embodiment of the present invention. The panel 10 comprises an array of pixels, which may be defined by the structures described above. The electronic device 110 may further include within a suitable housing, a user input interface such as keys and buttons (schematically represented by the block 116), image data control electronics, such as a controller (schematically represented by block 112) for managing image data flow to the LCD panel 10, electronics specific to the electronic device 110, which may include a processor, A/D converters, memory devices, data storage devices, etc. (schematically collectively represented by block 118), and a power source such as a power supply, battery or jack for external power source (schematically represented by block 114), which components are well known in the art.

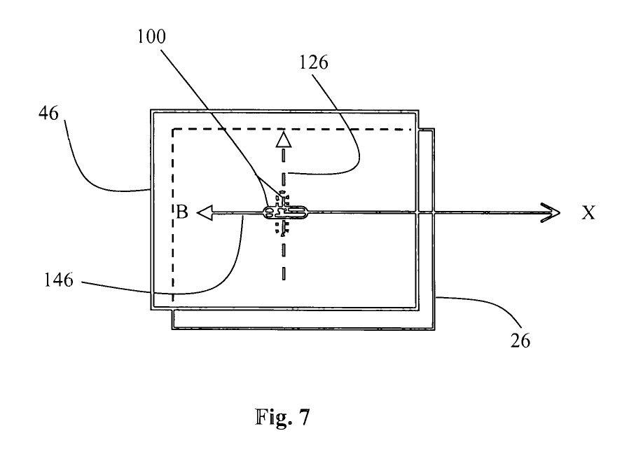

Factors controlling the morphology of the microscopic grooves include the speed, pressure and number of strokes of the rollers in addition to the type and directions of the velvet cloth. According to an embodiment shown in FIG. 6, the microscopic groove directions 126 and 146 on the alignment layers 26 and 46 are formed in such a way that the “rear” alignment layer 26 has its groove direction 126 oriented at approximately 90° relative to the X-axis, or in the case of a rectangular display area, oriented substantially parallel to the edge of the display are, and further in the case of rectangular planar substrate structures as in the illustrated embodiment, oriented substantially parallel to one edge of the rectangular substrate structure 16. The “front” alignment layer 46 has its groove direction 146 oriented at approximately 180° to the X-axis, or to the edge of the rectangular display area, or to the edge of the rectangular planar substrate structures. This orthogonal groove directions help align the horizontal orientation B of the liquid crystal molecules 100 to “twist” from 180° to 90° (from front to read) with respect to the X-axis as shown in FIG. 7. For the particular embodiment described above, for the rectangular panel 10, the liquid crystal alignment grooves on the alignment layers 26 and 46 are substantially parallel to the edges of the respective rectangular alignment layers 26 and 46 and/or substrate structures 16 and 18, whereby the alignment grooved on the alignment layers 26 and 48 are orthogonal to each other in this embodiment. It is noted that the groove direction on the “front” alignment layer may be at 0°, 90°, or −90°, and the groove direction on the “rear” alignment layer may be at −90°, 0°, or 90°, respectively with the same effect.

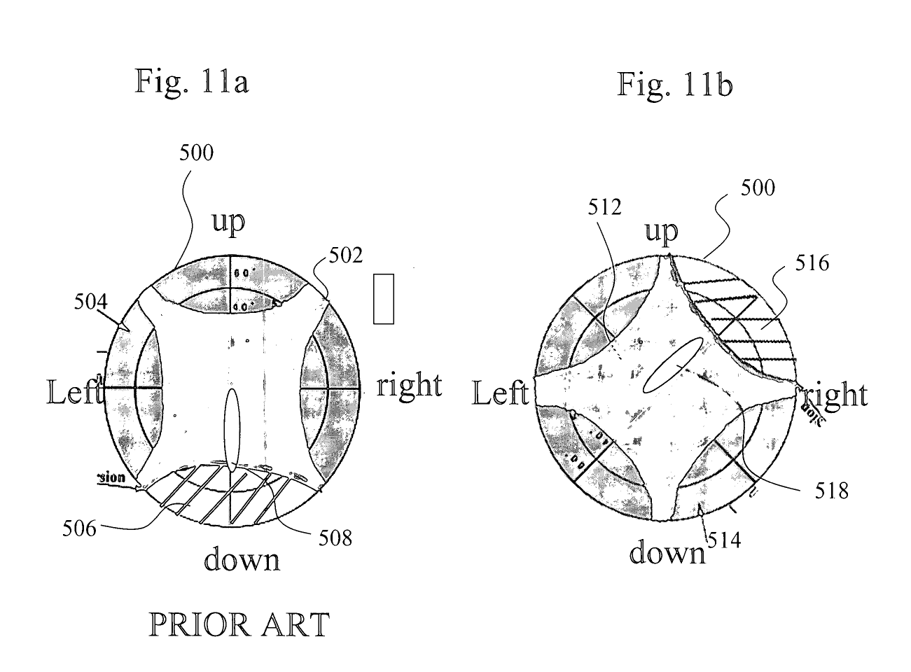

FIG. 11b is a plot of the contrast ratio versus viewing angles about a spot at the middle layer of the inventive LCD panel 10, essentially representing the contrast ratio of the views from all locations in a hemispherical domain that is centered about the spot. As in the case of FIG. 11a, the circles 500 represent the coordinates of viewing angles, increasing from the center of the circles outwards. The shaded areas represent the contrast ratio values. The solid dark areas 512 represent contrast ratio values of greater than 50 at the corresponding viewing angles and viewing locations. The gray shaded areas 514 represent contrast ratio values of less than 50 at the corresponding viewing angles and viewing locations. The hatched shaded areas 516 represent gray scale inversion at the corresponding viewing angles and viewing locations. The direction of the liquid crystal 518 at the mid section in the liquid crystal layer is schematically represented in FIG. 11b.

In accordance with the present invention, one of the benefits is that the grayscale inversion that exists in prior art LCD device is shifted by 45° from the vertical plane 300 (as defined in FIG. 4). This result in a display with grayscale inversion only at one quadrant of view (e.g., in the illustrated embodiment, at the top right quadrant of the view), leaving the rest of the view with a contrast ratio higher than at least 10. According to the example shown in FIG. 11b, the contrast ratio is about 80, at the view angles from up, down, left and right.

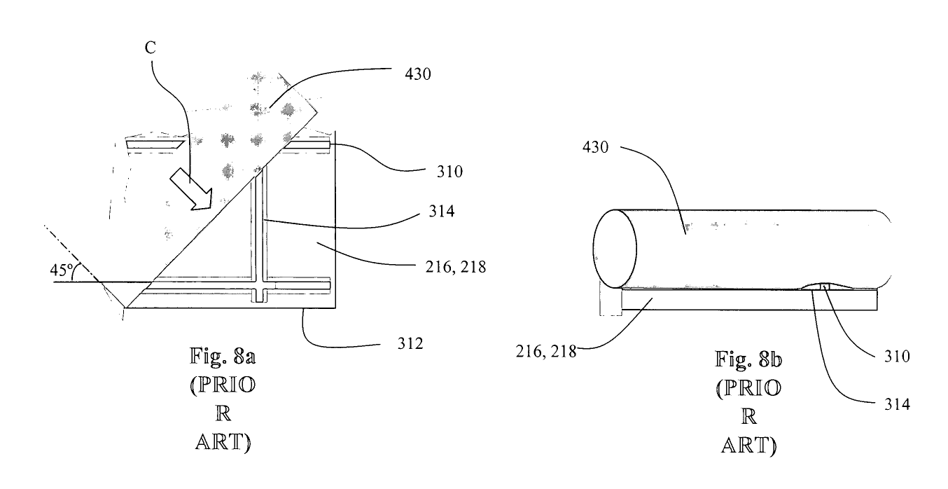

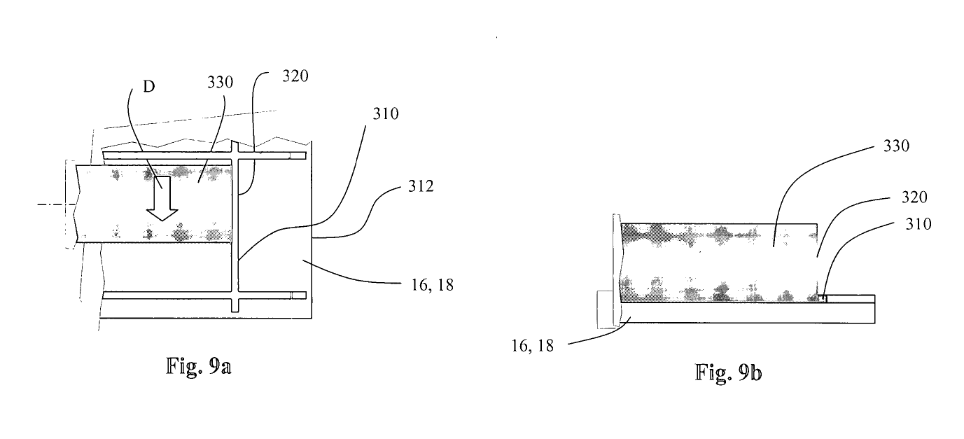

Another benefit of rubbing the alignment layer at 0° and 90° is to avoid interacting with the raised structures that are present on the transparent substrate structures, which are typically oriented parallel to either the horizontal or vertical edges 312 of the glass substrates. Referring to FIGS. 8a and 8b, which shows prior art substrate structures 216, 218. If the rubbing operation occurs after raised structures 310 have been created, areas 314 close to the raised structures 310 may not have sufficient contact with the roller 430 to form the microscopic grooves. The lack of microscopic grooves at areas 314 may cause rubbing defects such as light leakage and is amplified when the rubbing direction C is at 45° to the raised structures 310. Referring to FIGS. 9a and 9b, however, using the novel rubbing direction D of either 0° or 90° relative to the raised structures 310 would minimize rubbing defects because the edge 320 of the roller 330 can form microscopic grooves at areas close to the raised structures 310 that are sheltered by the raised structures 310 in the prior are processes.

Another advantage of the present invention is that for the same size substrate, by rubbing the grooves parallel to the substrates (16, 18), the roller 330 used can be narrower (i.e., shorter in axial length) than the roller 430. This allows larger substrates to be produced using existing rollers that are in current use, for producing larger LCD panels, or producing more smaller LCD panels, thus increasing manufacturing throughput.

In one embodiment of the present invention, the LCD panel is constructed such that its “rear” optical axis, as defined by its “rear” polarizer, alignment layer and compensation layer can vary between −20° and +20° with respect to the X-axis and its “front” optical axis can vary between +70° and +110° with respect to the X-axis. In another embodiment, the LCD panel is constructed such that its “rear” optical axis can vary between +70° and +110° with respect to the X-axis and its “front” optical axis can vary between +160° and +200° with respect to the X-axis. Yet in another embodiment, the LCD panel is constructed such that its “rear” optical axis can vary between +160° and +200° with respect to the X-axis and its “front” optical axis can vary between +250° and +290° with respect to the X-axis. Still in another embodiment, the LCD panel is constructed such that its “rear” optical axis can vary between +250° and +290° with respect to the X-axis and its “front” optical axis can vary between −20° and +20° with respect to the X-axis.

In another embodiment of the present invention, the LCD panel is constructed such that its “rear” optical axis, as defined by its “rear” polarizer, alignment layer and compensation layer can vary between +70° and +110° with respect to the X-axis and its “front” optical axis can vary between −20° and +20° with respect to the X-axis. Still in another embodiment, the LCD panel is constructed such that its “rear” optical axis can vary between +160° and +200° with respect to the X-axis and its “front” optical axis can vary between +70° and +110° with respect to the X-axis. Yet in another embodiment, the LCD panel is constructed such that its “rear” optical axis can vary between +250° and +290° with respect to the X-axis and its “front” optical axis can vary between +160° and +200° with respect to the X-axis. Still in another embodiment, the LCD panel is constructed such that its “rear” optical axis can vary between −20° and +20° with respect to the X-axis and its “front” optical axis can vary between +250° and +290° with respect to the X-axis.

Even though the embodiments described above involves rubbing the alignment layer surface with a velvet cloth wrapped around a rotating drum to the form microscopic parallel groove, it can be appreciated that other microgroove formation process may be substituted. For example, the microscopic grooves can be created using a load rubbing technique where a known weight is covered with velvet and is drawn across the substrate at a controlled uniform speed. Alternately, the grooves can be formed using a physical mold. Additionally, a supplemental alignment process such as photo-induced alignment of the liquid crystal with polarized light may be used to create a more uniformed orientation of the liquid crystal molecules.

Although the embodiments of the present invention describe an active-matrix LCD panel, it can be appreciated by one skilled in the art that the novel design used by the invention also applies to passive-matrix LCD panels.

While particular embodiments of the invention have been described herein for the purpose of illustrating the invention and not for the purpose of limiting the same, it will be appreciated by those of ordinary skill in the art that numerous variations of the details, materials, and arrangements of parts may be made without departing from the scope of the invention as defined in the appended claims.

1. An LCD panel defining a rectangular display area, comprising:
a first substrate structure, comprising a first alignment layer provided with a plurality of first alignment grooves;
a second substrate structure opposing the first substrate structure, comprising a second alignment layer provided with a plurality of second alignment grooves; and
a layer of liquid crystal disposed between the first substrate structure and the second substrate structure,
wherein the first alignment grooves are aligned at an angle close to an axis parallel to one edge of the display area, and the second alignment grooves are aligned orthogonal to the first alignment grooves.

2. The LCD panel as in claim 1, wherein the angle ranges from +20° to −20° relative to said one edge.

3. The LCD panel as in claim 2, wherein the angle is substantially 0° relative to said one edge.

4. The LCD panel as in claim 1, wherein at least the first substrate structure has a rectangular planar area, wherein the first alignment grooves are aligned at an angle close to an axis parallel to one edge of the first substrate structure.

5. The LCD panel as in claim 1, further comprising a compensation layer having an optical axis parallel to the angle of the alignment layer.

6. The LCD panel as in claim 1, further comprising a polarizer layer having an optical axis parallel to the angle of the alignment layer.

7. An electronic device, comprising:
the LCD panel as in claim 1;
control electronics operatively coupled to the LCD panel, providing an image data to render an image on the LCD panel.

8. A substrate structure for an LCD panel, comprising:
a substrate; and
an alignment layer supported by the substrate, said alignment layer provided with a plurality of alignment grooves,
wherein the alignment grooves are aligned at an angle close to an axis parallel to one edge of the substrate.

9. A LCD panel, comprising:
a first substrate structure having the substrate structure as in claim 8;
a second substrate structure opposing the first substrate structure and having the substrate structure as in claim 8, wherein the first substrate structure is oriented with respect to the second substrate structure with the alignment grooves in the first substrate structure orthogonal to the alignment grooves in the second substrate structure; and
a layer of liquid crystal disposed between the first substrate structure and the second substrate structure.

10. A method for forming a substrate structure for an LCD panel, comprising the steps of:
providing a substrate;
supporting an alignment layer by the substrate;
forming a plurality of alignment grooves on the alignment substrate, wherein the alignment grooves are aligned at an angle close to an axis parallel to one edge of the substrate.

11. A method of forming a LCD panel, comprising the steps of:
forming a first substrate structure in accordance with the method as in claim 10;
forming a second substrate structure in accordance with the method as in claim 10, wherein the first substrate structure is oriented with respect to the second substrate structure with the alignment grooves in the first substrate structure orthogonal to the alignment grooves in the second substrate structure; and
disposing a layer of liquid crystal between the first substrate structure and the second substrate structure.
